(19) United States
(12) Patent Application Publication
(10) Pub. No.: US 2025/0026626 A1
(43) Pub. Date: Jan. 23, 2025

(54) PRODUCT CONTAINER

(71) Applicant: TAINR, Los Angeles, CA (US)

(72) Inventor: CAMILO GIRALDO, Los Angeles, CA (US)

(73) Assignee: TAINR, Los Angeles, CA (US)

(21) Appl. No.: 18/778,922

(22) Filed: Jul. 20, 2024

Related U.S. Application Data
(60) Provisional application No. 63/515,062, filed on Jul. 21, 2023.

(51) Int. Cl. B67D 1/08

(52) U.S. Cl. CPC B67D 1/0804; B67D 1/0841; B67D 2001/0811

(57) ABSTRACT

A product container can include an insert and a collar coupled to a flexible bag. The product container can be assembled by sliding the insert at least partially into a neck of the bag, sliding the collar over the insert and the neck, and coupling the insert and the collar to one another and to the bag.

### CROSS-REFERENCE TO RELATED APPLICATIONS

This application claims the benefit of U.S. Provisional Patent Application No. 63/515,062 filed Jul. 21, 2023, the entire contents of which are incorporated herein by reference. This application is related to U.S. patent application Ser. No. 18/318,702 filed May 16, 2023, U.S. patent application Ser. No. 17/858,061 filed Jul. 5, 2022, and U.S. Provisional Patent Application No. 63/218,529 filed Jul. 6, 2021, the entire contents of which are incorporated herein by reference.

### TECHNICAL FIELD

The present disclosure relates generally to containers and more specifically relates to containers for dispensing machines, such as those used to dispense dry goods.

### BACKGROUND

Dispensing and/or transportation of product is often complicated by spillage, shrinkage, contamination, inventory management, quantification, identification, and sales. Single-use packaging adds costs to the product and burdens the environment.

### SUMMARY

Applicant has created new and useful devices, systems and methods for product containers. In at least one embodiment, a product container can include a bag, an insert, a collar, a cap, or any combination thereof. In at least one embodiment, the bag can be resilient and/or otherwise flexible. In at least one embodiment, the bag can include a resilient neck. In at least one embodiment, the resilient neck can receive the insert therein. In at least one embodiment, the resilient neck can include at least one hole therethrough.

In at least one embodiment, the collar can be rigid. In at least one embodiment, the collar can be threaded, such as along an outward surface thereof. In at least one embodiment, the collar can be configured to be coupled with the bag. In at least one embodiment, the cap can be rigid. In at least one embodiment, the cap can be threaded, such as along an inwardly facing surface thereof. In at least one embodiment, the cap can be configured to seal the container, such as by being thread ably received on the collar.

In at least one embodiment, the insert can be rigid. In at least one embodiment, the insert can be positioned at least partially within the bag. In at least one embodiment, the insert can be configured to engage the collar outside the bag. In at least one embodiment, the insert can be configured to secure the collar to the bag. In at least one embodiment, the insert can include at least one outwardly extending pin configured to penetrate the bag and engage the collar. In at least one embodiment, the hole in the neck of the bag can receive the pin therethrough. In at least one embodiment, the collar can include at least one inwardly facing slot configured to receive the pin.

In at least one embodiment, the collar can include at least one outwardly extending lever. In at least one embodiment, the insert can include at least one inwardly extending handle. In at least one embodiment, the lever and the handle can facilitate engagement of the insert and the collar, such as by facilitating engagement of the pin and the slot. In at least one embodiment, the lever can also facilitate alignment of the collar with a product dispensing station of a dispensing machine.

In at least one embodiment, the container can include an adapter configured to mate the container with a product dispensing station of a dispensing machine. In at least one embodiment, the collar and/or the adapter can include at least one magnet and/or at least one magnet target. In at least one embodiment, the magnet and the magnet target can be positioned to mate the collar to the adapter. In at least one embodiment, both the magnet and the magnet target can be magnetized.

In at least one embodiment, the collar can include at least one identification tag. In at least one embodiment, the adapter can include at least one tag reader that can assist in identification of the container. In at least one embodiment, the collar can include at least one identification tag configured to be accessed by a tag reader of a dispensing machine in order to identify the container.

In at least one embodiment, a product container can include a flexible bag, a rigid insert, a collar, a cap, an adapter, or any combination thereof. In at least one embodiment, the flexible bag can include a resilient neck and/or at least one hole therethrough, such as through the neck. In at least one embodiment, the insert can be positioned at least partially within the bag, such as at least partially within the neck. In at least one embodiment, the insert can include at least one outwardly extending pin. In at least one embodiment, the pin can extend through the hole. In at least one embodiment, the insert can include at least one inwardly extending handle.

In at least one embodiment, the collar can be threaded, such as along an outward surface thereof. In at least one embodiment, the collar can be positioned exterior to the bag. In at least one embodiment, the collar can include at least one inwardly facing slot, such as to receive the pin thereby securing the collar to the bag. In at least one embodiment, the collar can include at least one outwardly extending lever. In at least one embodiment, the lever and/or the handle can facilitate engagement of the pin within the slot and/or otherwise facilitate engagement of the collar and the insert. In at least one embodiment, the lever can facilitate alignment of the collar with a product dispensing station of a dispensing machine. In at least one embodiment, the cap can be threaded, such as along an inwardly facing surface thereof. In at least one embodiment, the cap can be threaded onto the collar, thereby sealing the container.

In at least one embodiment, the container can include an adapter configured to properly position the container with respect to a product dispensing station of a dispensing machine. In at least one embodiment, the collar and/or the adapter can include at least one magnet and/or at least one magnet target. In at least one embodiment, the magnet and the magnet target can be positioned on the collar and/or the adapter, to properly position the collar with respect to the adapter. In at least one embodiment, both the magnet and the magnet target can be magnetized.

In at least one embodiment, the collar can include an identification tag or device, such as a radio frequency identification (RFID) tag or chip. In at least one embodiment, the adapter can include a tag reader that can assist in identification of the container. In at least one embodiment, the identification tag can be accessed by a tag reader of a dispensing machine in order to identify the container.

In at least one embodiment, a product container can be assembled by sliding an insert at least partially into a neck of a flexible bag, sliding a collar over the insert and the neck until a pin abuts a longitudinal end of an inwardly facing slot in the collar, rotating the collar about a longitudinal axis of the insert until the pin abuts a terminal point in the slot, or any combination thereof.

In at least one embodiment, a product container can be assembled by sliding, longitudinally, an insert at least partially into a resilient neck of a flexible bag, such that at least one pin of the insert protrudes latitudinally outwardly from the neck, sliding, longitudinally, a collar over the insert and the neck until the pin abuts a longitudinal wall of an inwardly facing slot in the collar, rotating the collar about a longitudinal axis of the insert until the pin abuts a terminal point in the slot, or any combination thereof.

### BRIEF DESCRIPTION OF THE DRAWINGS

FIG. 1 is a perspective view of one of many embodiments of a dispensing machine according to the disclosure.

FIG. 2 is a front elevation view of one of many embodiments of a dispensing machine according to the disclosure.

FIG. 3 is a close-up perspective view of one of many embodiments of a portion of a dispensing machine according to the disclosure.

FIG. 4 is another close-up perspective view of one of many embodiments of a portion of a dispensing machine according to the disclosure.

FIG. 5 is a close-up perspective view of one of many embodiments of a dispensing station of a dispensing machine according to the disclosure.

FIG. 6 is a perspective view of one of many embodiments of a product container according to the disclosure.

FIG. 7 is a front elevation view of one of many embodiments of a product container according to the disclosure.

FIG. 8 is a front elevation view of another of many embodiments of a product container according to the disclosure.

FIG. 9 is a front elevation view of still another of many embodiments of a product container according to the disclosure.

FIG. 10 is another perspective view of one of many embodiments of a product container according to the disclosure.

FIG. 11 is a perspective view of one of many embodiments of a portion of a product container according to the disclosure.

FIG. 12 is a perspective view of one of many embodiments of an insert of a product container according to the disclosure.

FIG. 13 is an elevation view of one of many embodiments of a bag of a product container according to the disclosure.

FIG. 14 is an elevation view of one of many embodiments of a collar of a product container according to the disclosure.

FIG. 15 is a perspective view of the collar of FIG. 14.

FIG. 16 is a bottom plan view of the collar of FIG. 14.

FIG. 17 is another perspective view of the collar of FIG. 14.

FIG. 18 is an elevation view of one of many embodiments of an adapter of a product container according to the disclosure.

### DETAILED DESCRIPTION

The figures described above and the written description of specific structures and functions below are not presented to limit the scope of what Applicant has invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms.

The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the figures and are not intended to limit the scope of the inventions or the appended claims. The terms “including” and “such as” are illustrative and not limitative. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally. Further, all parts and components of the disclosure that are capable of being physically embodied inherently include imaginary and real characteristics regardless of whether such characteristics are expressly described herein, including but not limited to characteristics such as axes, ends, inner and outer surfaces, interior spaces, tops, bottoms, sides, boundaries, dimensions (e.g., height, length, width, thickness), mass, weight, volume and density, among others.

Applicant has created new and useful devices, systems and methods for product containers. In at least one embodiment, a product container according to the disclosure can include a flexible bag for holding one or more products and a cap assembly coupled to an open end of the bag for selectively opening and closing the container and cooperating with a product dispenser, such as a dry foods dispenser located in a grocery store or other location. Embodiments of the disclosure can advantageously provide for collapsible, reusable product storage and convenient, hygienic distribution of dry foods and/or other goods, thereby reducing plastic waste and minimizing the spread of germs that can be associated with, e.g., traditional dry food distribution centers or kiosks often found in grocery stores and the like. Examples of such dry foods include, but are not limited to, nuts, dried fruits, coffee beans, candy and other foods often distributed in bulk form.

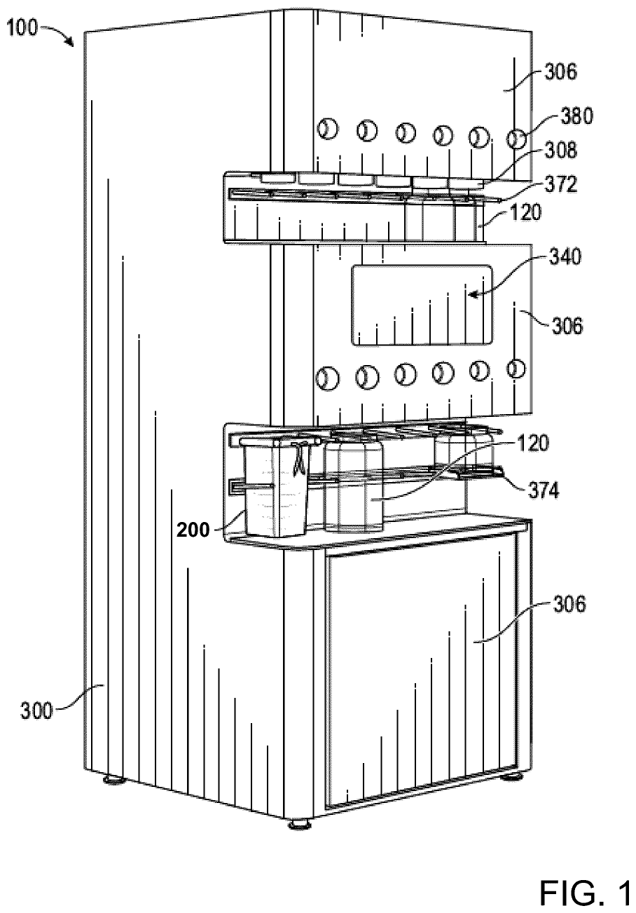

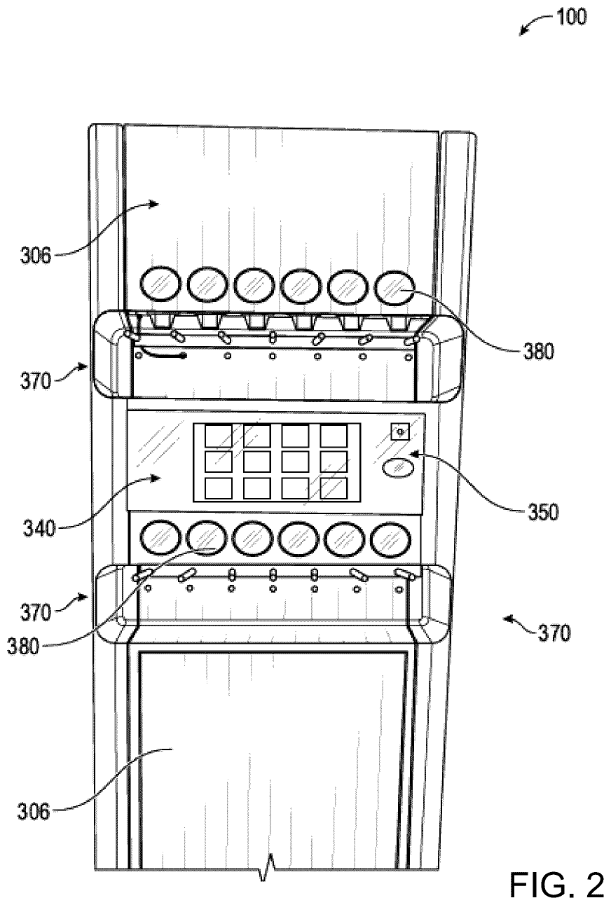

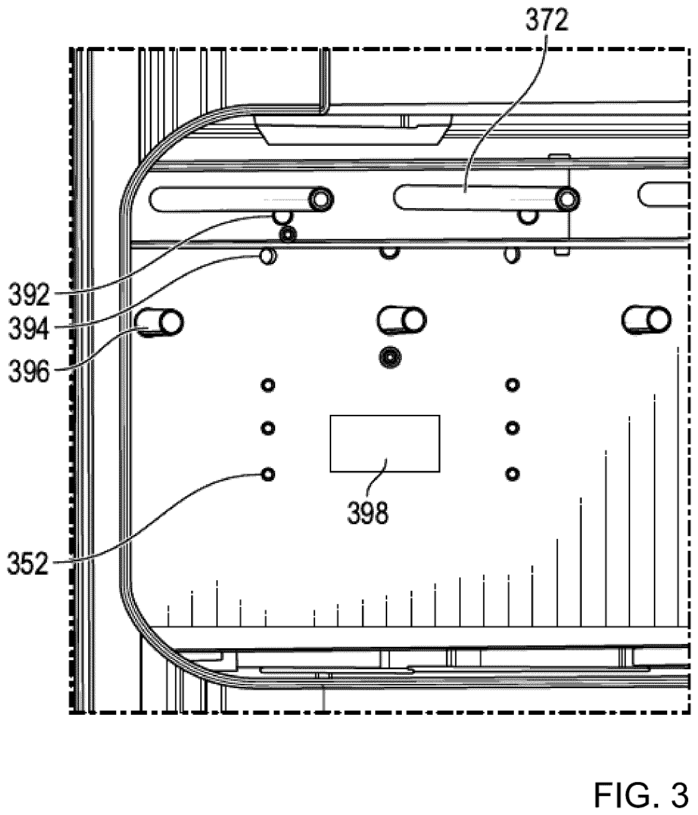

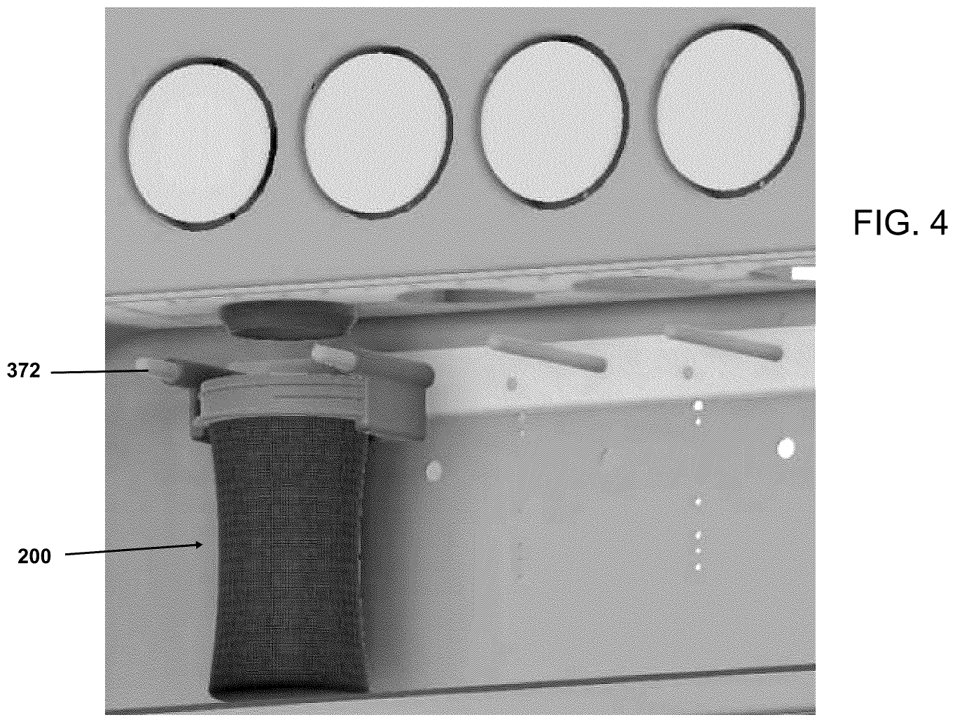

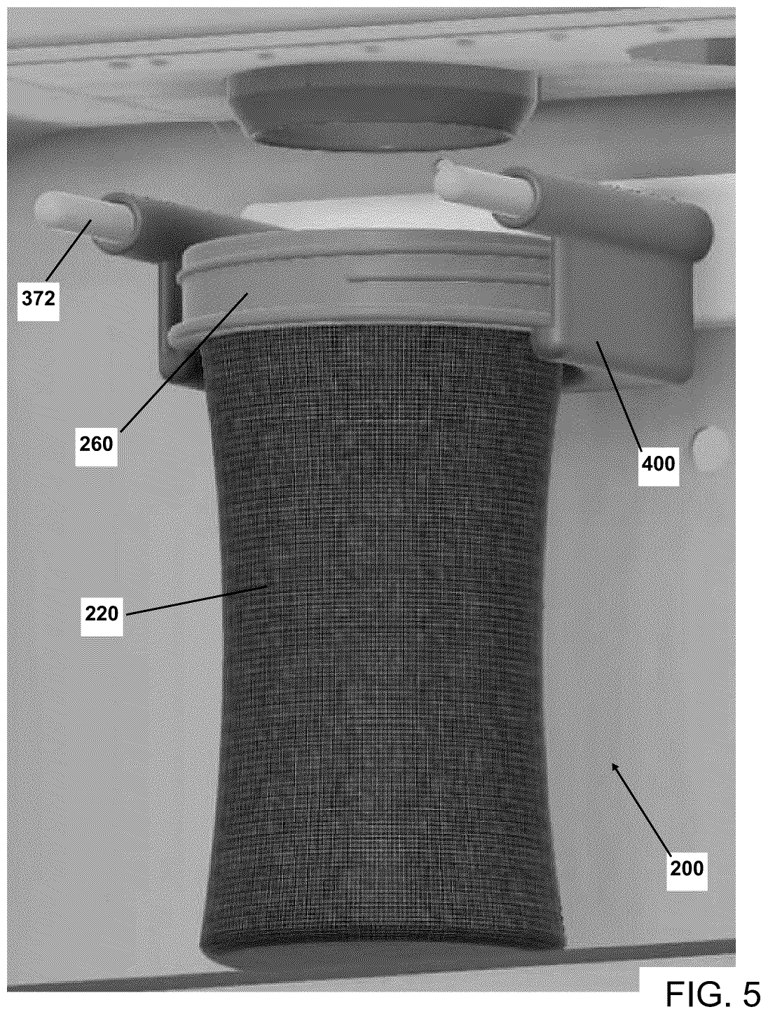

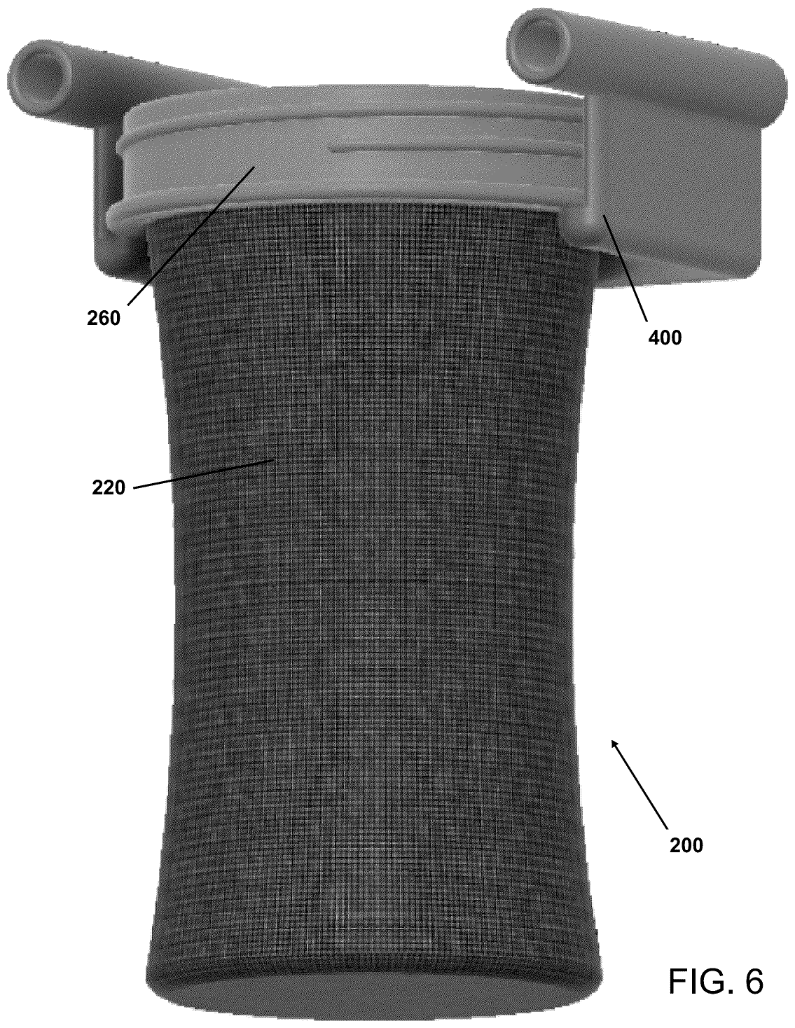

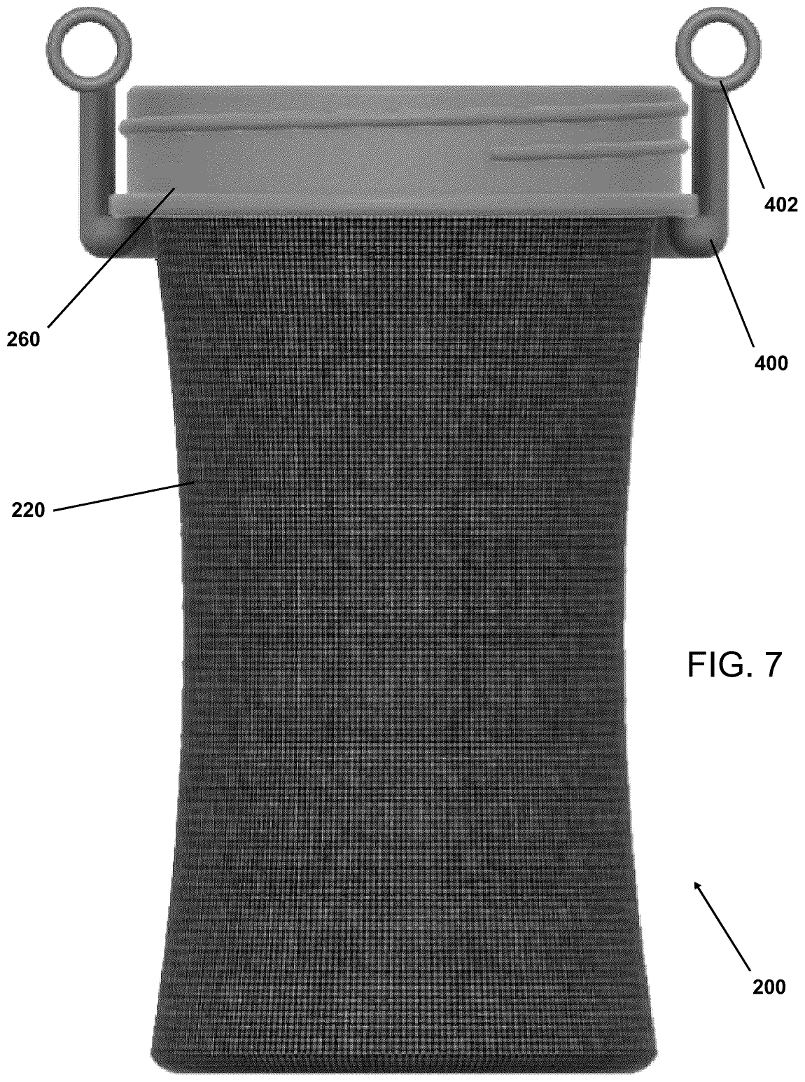

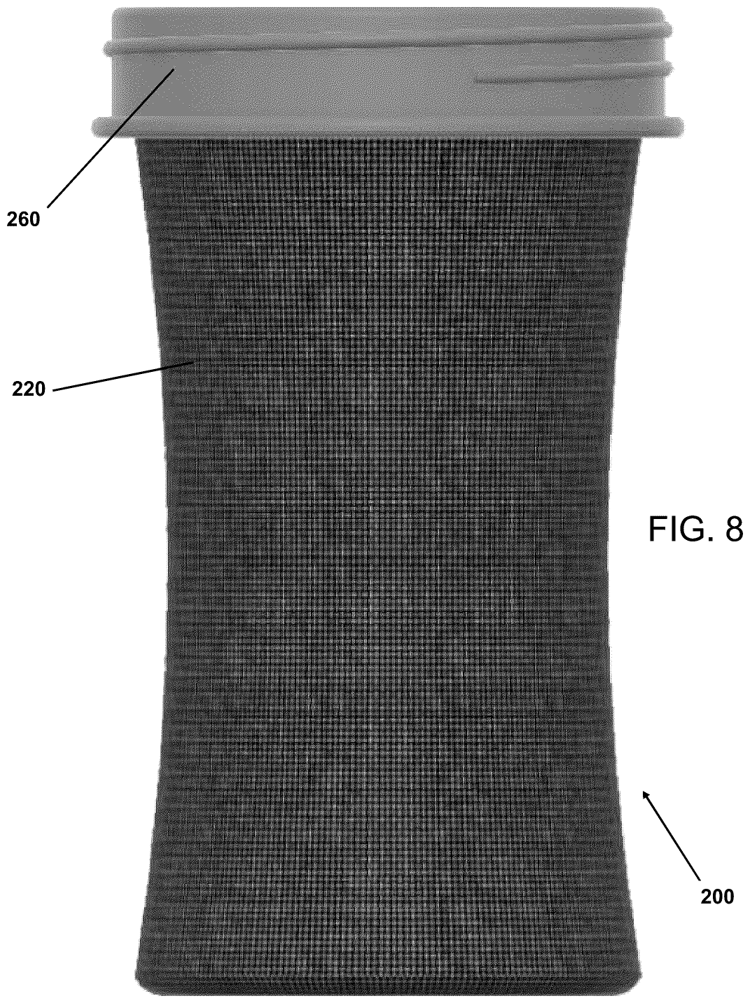

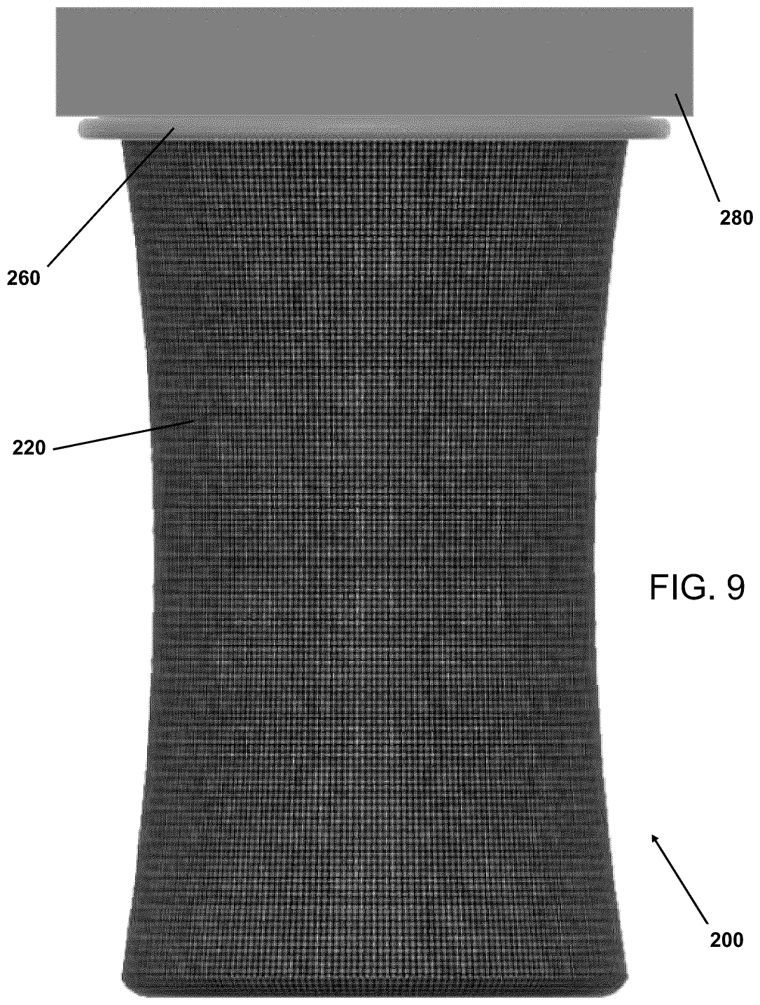

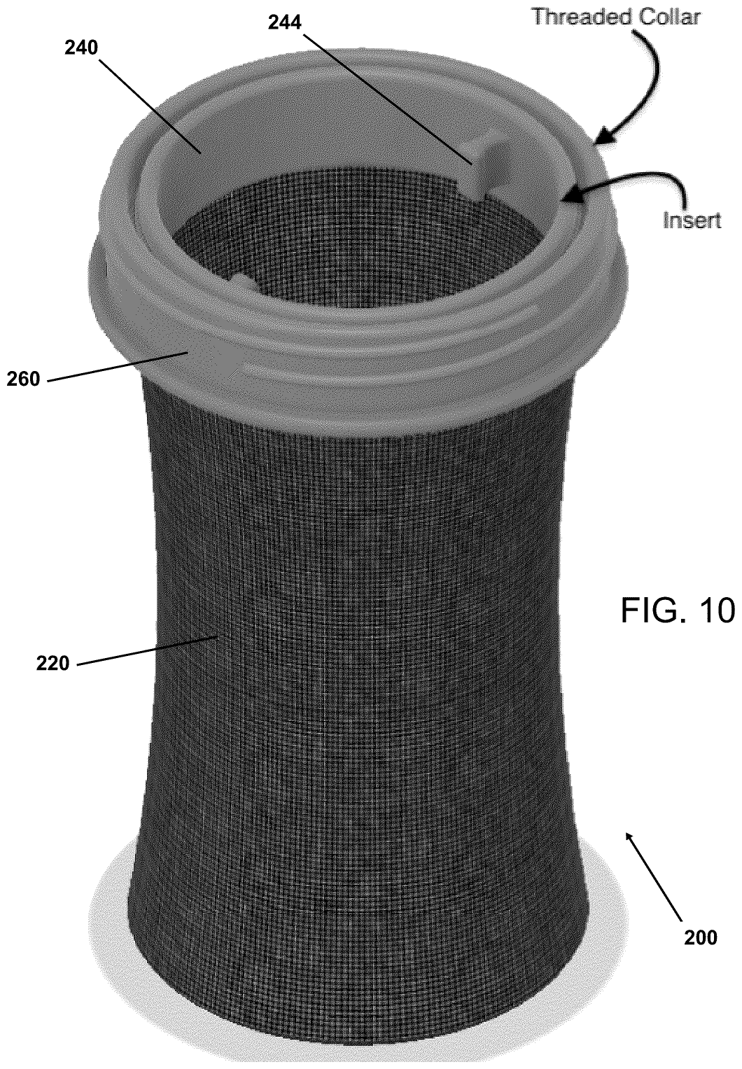

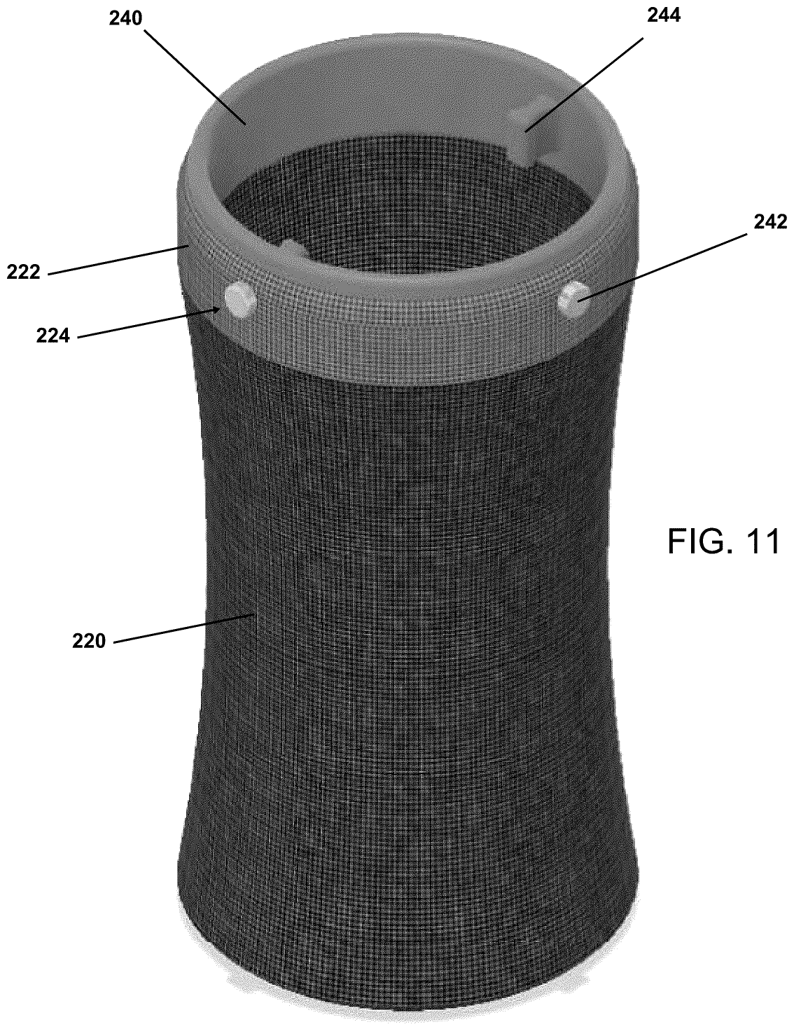

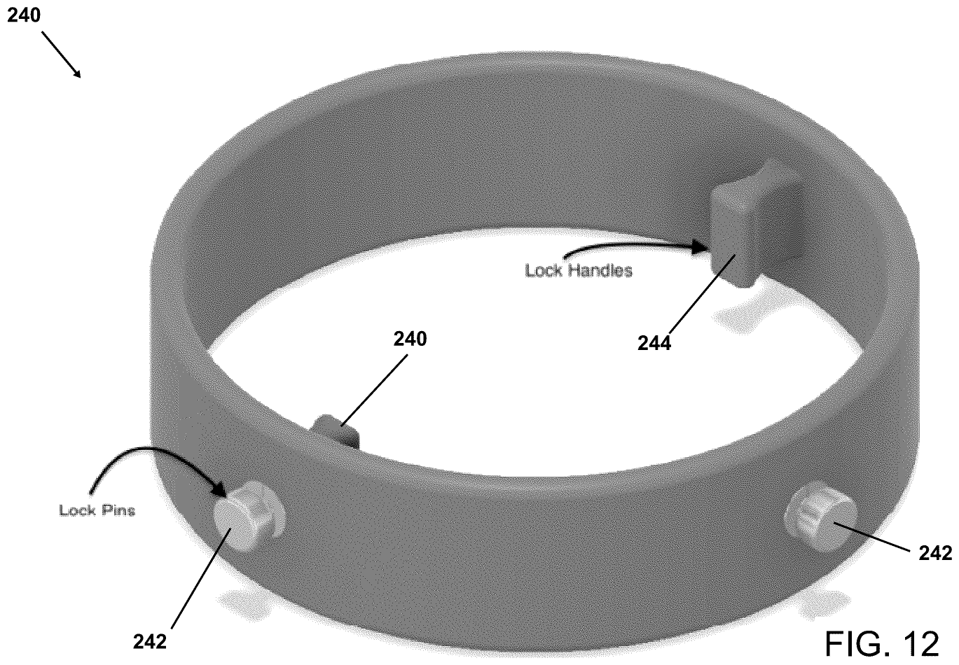

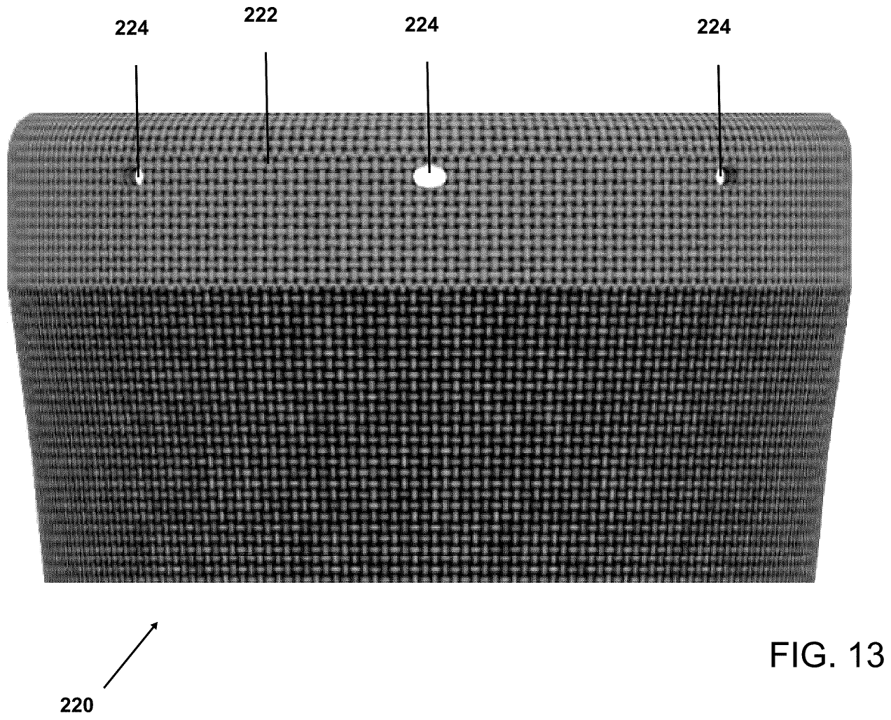

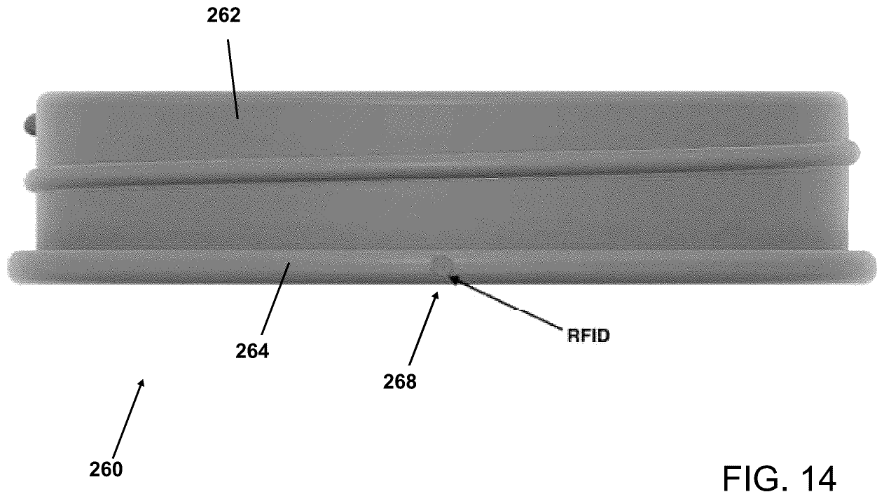

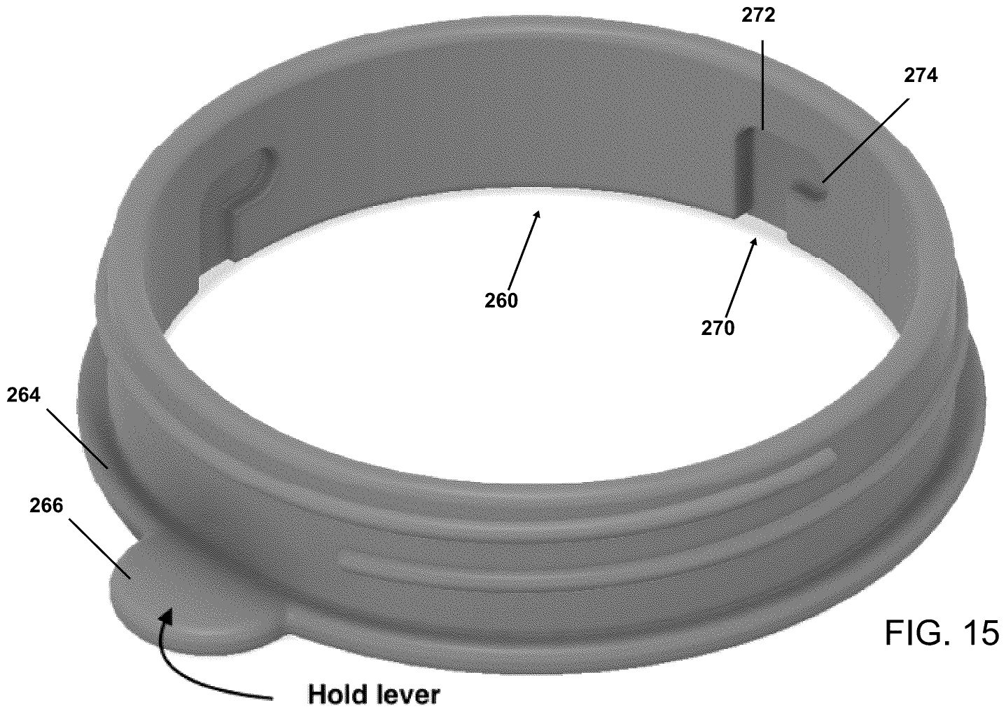

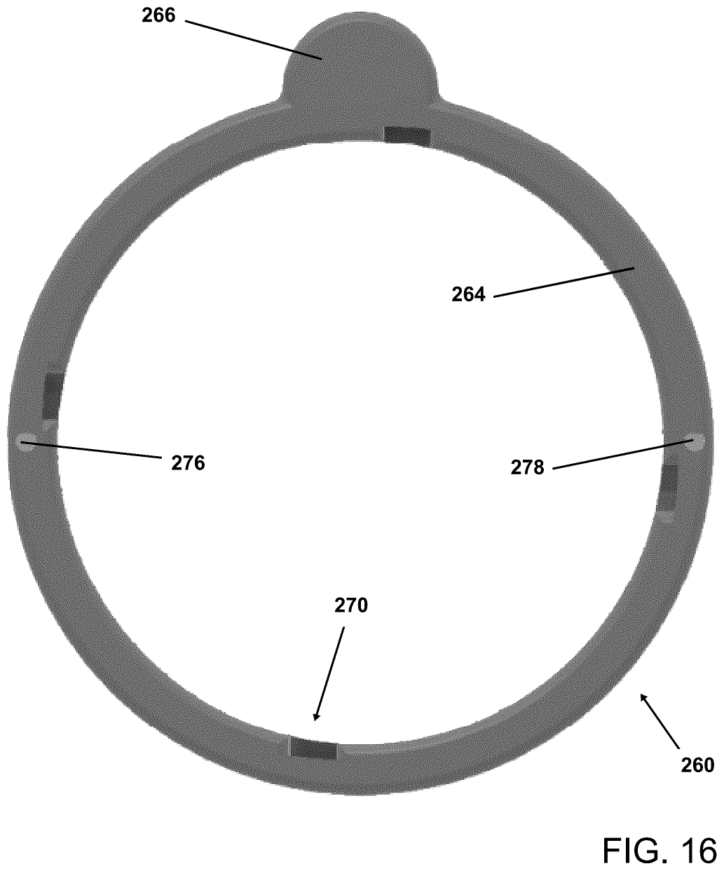

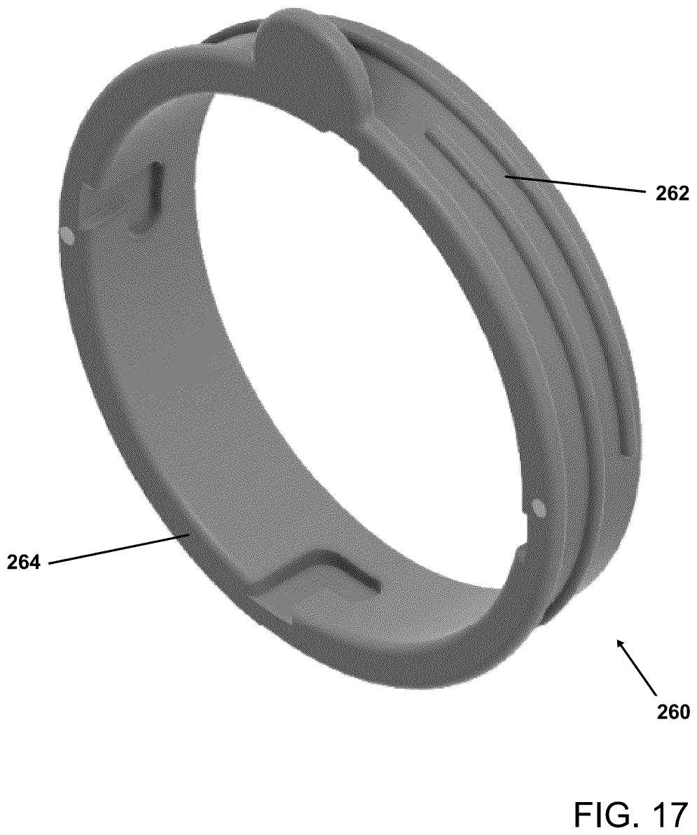

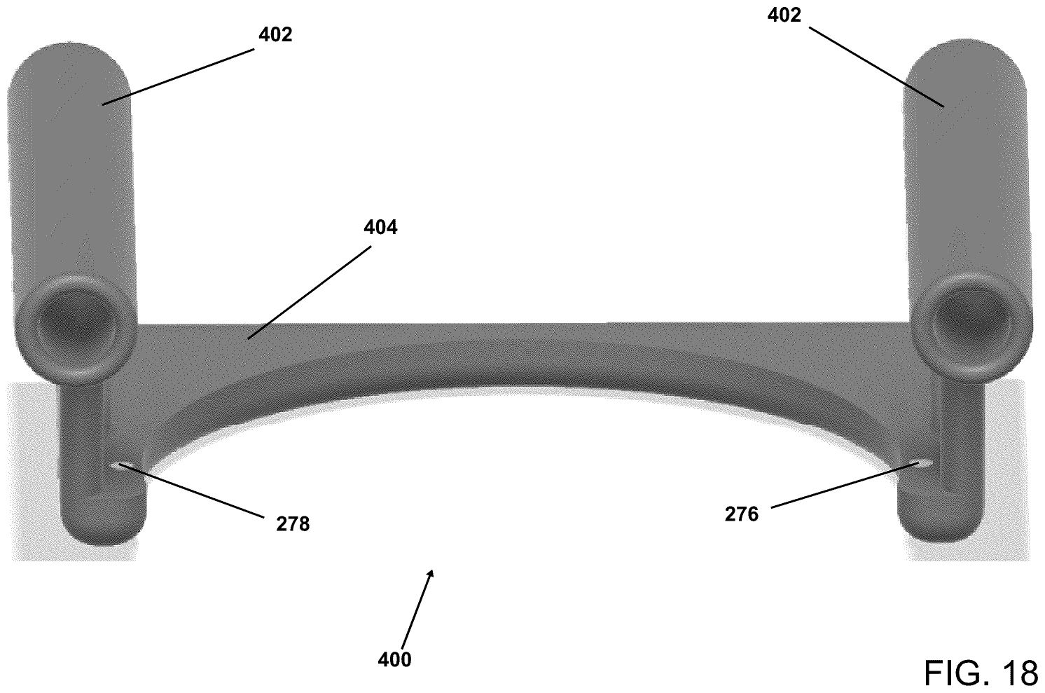

FIG. 1 is a perspective view of one of many embodiments of a dispensing machine according to the disclosure. FIG. 2 is a front elevation view of one of many embodiments of a dispensing machine according to the disclosure. FIG. 3 is a close-up perspective view of one of many embodiments of a portion of a dispensing machine according to the disclosure. FIG. 4 is another close-up perspective view of one of many embodiments of a portion of a dispensing machine according to the disclosure. FIG. 5 is a close-up perspective view of one of many embodiments of a dispensing station of a dispensing machine according to the disclosure. FIG. 6 is a perspective view of one of many embodiments of a product container according to the disclosure. FIG. 7 is a front elevation view of one of many embodiments of a product container according to the disclosure. FIG. 8 is a front elevation view of another of many embodiments of a product container according to the disclosure. FIG. 9 is a front elevation view of still another of many embodiments of a product container according to the disclosure. FIG. 10 is another perspective view of one of many embodiments of a product container according to the disclosure. FIG. 11 is a perspective view of one of many embodiments of a portion of a product container according to the disclosure. FIG. 12 is a perspective view of one of many embodiments of an insert of a product container according to the disclosure. FIG. 13 is an elevation view of one of many embodiments of a bag of a product container according to the disclosure. FIG. 14 is an elevation view of one of many embodiments of a collar of a product container according to the disclosure. FIG. 15 is a perspective view of the collar of FIG. 14. FIG. 16 is a bottom plan view of the collar of FIG. 14. FIG. 17 is another perspective view of the collar of FIG. 14. FIG. 18 is an elevation view of one of many embodiments of an adapter of a product container according to the disclosure. FIGS. 1-18 are described in conjunction with one another.

In at least one embodiment, a machine or system 100 for dispensing products can include one or more product bins, a housing 300 having a plurality of cavities or spaces to selectively receive the product bins, and one or more controllers to selectively dispense product. In at least one embodiment, housing 300 can include one or more access doors 306 to access the various sensors, bins, and/or other components of the system 100. In at least one embodiment, housing 300 can include one or more nozzles 308 to direct flow of the product(s) from one or more corresponding bins. In at least one embodiment, housing 300 can include one or more touchscreen displays 340 providing a user interface 350.

In at least one embodiment, housing 300 can include one or more product dispensing stations 370 positioned below bins or nozzles 308. In at least one embodiment, housing 300 can include one or more product view ports 380 positioned above product dispensing stations 370. In at least one embodiment, product dispensing stations 370 can selectively receive and support one or more rigid transportation containers 120 and/or one or more flexible product containers 200. In at least one embodiment, product dispensing stations 370 can include one or more alignment posts 372 that can align, suspend, or otherwise support one or more rigid transportation containers 120 and/or one or more flexible product containers 200. In at least one embodiment, product dispensing stations 370 can include one or more movable and/or removable shelves 374 to support smaller transportation containers 120 or product containers 200.

In at least one embodiment, product dispensing stations 370 can include one or more lights 352, such as light emitting diodes or other light sources, to provide a user with an indication of where, such as at which dispensing station(s) 370, to place a transportation container 120 and/or one or more flexible product containers 200. In at least one embodiment, product dispensing stations 370 can include one or more vending sensors. In at least one embodiment, vending sensors can include one or more magnetic sensor(s) 392, one or more proximity sensor(s) 394, one or more other sensor(s) 396, one or more RFID sensor(s) 398, or any combination thereof.

In at least one embodiment, a dispensing machine or system 100 for dispensing products can be or include such a machine or system as more fully described in any of U.S. patent application Ser. No. 18/318,702 filed May 16, 2023, U.S. patent application Ser. No. 17/858,061 filed Jul. 5, 2022, and/or U.S. Provisional Patent Application No. 63/218,529 filed Jul. 6, 2021. However, this need not be the case and, in at least one embodiment, one or more product containers 200 according to the disclosure can be utilized with other dispensing machines or systems and/or in the absence of any such dispensing machine or system.

In at least one embodiment, a product container 200 according to the disclosure can include one or more bags 220, one or more inserts 240, one or more collars 260, one or more caps 280, or any combination thereof. In at least one embodiment, bag 220 can be resilient, flexible and/or collapsible. In at least one embodiment, bag 220 can be constructed of a polymer and/or a woven material. In at least one embodiment, bag 220 can be waterproof, vapor permeable, vapor impermeable, or any combination thereof. In at least one embodiment, bag 220 can be constructed, wholly or partially, of a mesh fabric. In at least one embodiment, bag 220 can be washable, dryable, reusable, recyclable, replaceable, or any combination thereof.

In at least one embodiment, bag 220 can include a neck 222. In at least one embodiment, neck 222 can be open to accept product therethrough and/or an opposing end of bag 220 can be closed, in order to contain product therewithin. In at least one embodiment, neck 222 can receive the insert 240 therein. In at least one embodiment, neck 222 can include at least one hole 224 therethrough. In at least one embodiment, neck 222 can be made of the same material as the rest of bag 220 and/or of a different material. In at least one embodiment, neck 222 can be treated, such as with an adhesive or the like, or can otherwise have greater resilience or stiffness than one or more other portions of bag 220.

In at least one embodiment, collar 260 can be flexible and/or rigid, and can include one or more flexible and/or rigid portions. In at least one embodiment, collar 260 can be constructed of a rigid metal and/or polymer. In at least one embodiment, collar 260 can be constructed of a flexible material, such as a polymer. In at least one embodiment, collar 260 can be threaded, such as along an outward surface 262 thereof. In at least one embodiment, collar 260 can include one or more lips or flanges 264. In at least one embodiment, collar 260 can include one or more outwardly extending levers 266. In at least one embodiment, lever 266 can facilitate alignment of collar 260 with a product dispensing station 370 of a dispensing machine 100, such as that described above.

In at least one embodiment, collar 260 can include one or more slots 270, such as radially or otherwise inwardly facing slots, for coupling with one or more other components of container 200. In at least one embodiment, slot 270 can include one or more longitudinal walls 272. In at least one embodiment, slot 270 can include one or more terminal portions or points 274. In at least one embodiment, collar 260 can be configured to be coupled with bag 220.

In at least one embodiment, collar 260 can include one or more magnets 276 and/or one or more magnetic or magnet targets 278. In at least one embodiment, magnet target 278 can be constructed of non-magnetized ferro magnetic material. In at least one embodiment, both magnet 276 and magnet target 278 can be magnetized.

In at least one embodiment, cap 280 can be flexible and/or rigid, and can include one or more flexible and/or rigid portions. In at least one embodiment, cap 280 can be constructed of a rigid metal and/or polymer. In at least one embodiment, cap 280 can be constructed of a flexible material, such as a polymer. In at least one embodiment, cap 280 can be threaded, such as along an inwardly facing surface thereof. In at least one embodiment, cap 280 can be configured to seal the container 200, such as by being configured to threadably or otherwise couple with collar 260.

In at least one embodiment, insert 240 can be flexible and/or rigid, and can include one or more flexible and/or rigid portions. In at least one embodiment, insert 240 can be constructed of a rigid metal and/or polymer. In at least one embodiment, insert 240 can be constructed of a flexible material, such as a polymer. In at least one embodiment, insert 240 can be positioned at least partially within bag 220. In at least one embodiment, insert 240 can be positioned at least partially within neck 222.

In at least one embodiment, insert 240 can be configured to engage collar 260, which can include coupling with collar 260 at least partially outside of or exterior of bag 220, such as radially outwardly thereof. In at least one embodiment, insert 240 can be configured to secure collar 260 to bag 220. In at least one embodiment, insert 240 can include one or more outwardly extending pins 242 configured to penetrate or be disposed through bag 220 and to engage or couple with collar 260 or a portion thereof. In at least one embodiment, one or more holes 224 in neck 222 of bag 220 can be configured to receive one or more corresponding pins 242 therethrough. In at least one embodiment, one or more slots 270 of collar 260 can be configured to receive at least a portion of one or more corresponding pins 242 therein and/or to otherwise couple therewith. In at least one embodiment, a longitudinal wall 272 of a slot 270 can guide a pin 242 towards a terminal point 274 of slot 270. In at least one embodiment, insert 240 can be secured to collar 260, with neck 222 of bag sandwiched therebetween, such as when one or more pins 242 are firmly seated against or otherwise coupled with one or more terminal points 274 of one or more corresponding slots 270.

In at least one embodiment, insert 240 can include one or more inwardly extending handles 244, such as one or more radially inwardly extending handles 244 that can protrude at least partially into an opening of bag 220. In at least one embodiment, lever 266 of collar 260 and/or handle 244 of insert 240 can facilitate engagement of insert 240 and collar 260, such as by facilitating engagement of pin 242 and slot 270. In other words, in at least one embodiment, one or more levers 266 of collar 260 and/or one or more handles 244 of insert 240 can be configured for allowing a user to grip collar 260 and insert 240 and rotate or otherwise move such components relative to one another for coupling and/or uncoupling the components.

In at least one embodiment, container 200 can include one or more adapters 400. In at least one embodiment, adapter 400 can be configured to mate container 200 with product dispensing station 370 of machine 100, such as by facilitating the position or positioning of container 200 relative to product dispensing station 370 such that container 200 can receive product(s) therein from machine 100. In at least one embodiment, adapter 400 can include one or more tubes 402 to engage one or more alignment posts 372 of product dispensing station 370 and/or one or more racks 404 to support flange 264 of collar 260, and thus bag 222. In at least one embodiment, adapter 400 can include one or more rigid portions which can be constructed of a rigid metal and/or polymer.

In at least one embodiment, collar 260 and/or adapter 400 can include one or more magnets 276 and/or one or more magnet targets 278. In at least one embodiment, magnets 276 and/or magnet targets 278 can be positioned and arranged for supporting proper mating, alignment or coupling of collar 260 and adapter 400. In at least one embodiment, collar 260 can include one or more identification tags 268. In at least one embodiment, tag 268 can include wireless communications functionality, such as radio frequency identification (RFID), Bluetooth, Wi-Fi, and/or similar wireless communications technology, and/or optical recognition functionality, such as color coding, bar coding, and/or optical recognition technology.

In at least one embodiment, adapter 400 can include one or more tag readers that can assist in identification of container 200. In at least one embodiment, collar 260 can include one or more tags 268 configured to be accessed by or to otherwise communicate with a tag reader, such as any one or more of the vending sensors of machine 100, in order to identify container 200. In at least one embodiment, identification of container 200 can be used to confirm that it is of the proper size, shape, configuration, construction, or any combination thereof. In at least one embodiment, identification of container 200 can be used to identify a user thereof and/or to facilitate payment for product dispensed therein. In at least one embodiment, identification of container 200 can be used to track usage thereof, such as to track the number of times a given container 200 is used and/or to estimate how much plastic waste, etc., was avoided by using container 200 rather than conventional plastic baggies or the like.

In at least one embodiment, a product container 200 according to the disclosure can include one or more flexible bags, one or more rigid inserts, one or more collars, one or more caps, one or more adapters, or any combination thereof. In at least one embodiment, flexible bag 220 can include a resilient neck 222 and/or one or more holes 224 therethrough, such as through the neck 222. In at least one embodiment, insert 240 can be positioned at least partially within bag 220, such as at least partially within neck 222. In at least one embodiment, insert 240 can include one or more outwardly extending pins 242. In at least one embodiment, pin 242 can extend through hole 224. In at least one embodiment, insert 240 can include one or more inwardly extending handles 244.

In at least one embodiment, collar 260 can be threaded, such as along an outward surface 262 thereof. In at least one embodiment, collar 260 can be positioned exterior to bag 220, such as around an outside of neck 222 of bag 220. In at least one embodiment, collar 260 can include one or more inwardly facing slots 270. In at least one embodiment, slot 270 can receive pin 242, thereby securing collar 260 to insert 240, with bag 220 secured therebetween, which in turn can secure collar 260 to bag 220. In at least one embodiment, collar 260 can include one or more outwardly extending levers 266. In at least one embodiment, lever 266 and/or handle 244 can facilitate engagement of pin 242 within slot 270 and/or otherwise facilitate engagement of collar 260 and insert 240. In at least one embodiment, lever 270 can facilitate alignment of collar 260 with adapter 400 and/or product dispensing station 370 of dispensing machine 100. In at least one embodiment, cap 280 can be threaded, such as along an inwardly facing surface thereof. In at least one embodiment, cap 280 can be threaded onto collar 260, thereby sealing container 200.

In at least one embodiment, container 200 can include one or more adapters 400 configured to properly position container 200 with respect to a product dispensing station 370 of a dispensing machine 100. In at least one embodiment, collar 260 and/or adapter 400 can include one or more magnets 276 and/or one or more magnet targets 278. In at least one embodiment, magnet 276 and magnet target 278 can be positioned, on collar 260 and/or adapter 400, to properly position collar 260, and thus bag 220, with respect to adapter 400, and thus product dispensing station 370. In at least one embodiment, both magnet 276 and magnet target 278 can be magnetized.

In at least one embodiment, the collar can include one or more identification tags or devices 268, such as an RFID tag or chip. In at least one embodiment, adapter 400 can include one or more tag readers that can assist in identification of container 200. In at least one embodiment, tag 256 can be accessed by or can otherwise communicate with a tag reader of a dispensing machine 100, such as one or more of the vending sensors, in order to identify container 200.

In at least one embodiment, a product container 200 according to the disclosure can be assembled by sliding an insert 240 at least partially into a neck 222 of a flexible bag 220, sliding a collar 260 over insert 240 and neck 222 until a pin 242 abuts a longitudinal end 272 of an inwardly facing slot 270 in collar 260, rotating collar 260 about a longitudinal axis of insert 240 until pin 242 abuts a terminal point 274 in slot 270, or any combination thereof.

In at least one embodiment, a product container 200 according to the disclosure can be assembled by sliding, longitudinally, an insert 240 at least partially into a resilient neck 222 of a flexible bag 220, such that at least one pin 242 of insert 240 protrudes latitudinally outwardly from neck 242, sliding, longitudinally, a collar 260 over insert 240 and neck 222 until pin 242 abuts a longitudinal wall 272 of an inwardly facing slot 270 in collar 260, rotating collar 260 about a longitudinal axis of insert 240 until pin 242 abuts a terminal point 274 in slot 270, or any combination thereof.

In at least one embodiment, a product container can include a bag, an insert, a collar, a cap, or any combination thereof. In at least one embodiment, the bag can be resilient and/or otherwise flexible. In at least one embodiment, the bag can include a resilient neck. In at least one embodiment, the resilient neck can receive the insert therein. In at least one embodiment, the resilient neck can include at least one hole therethrough.

In at least one embodiment, the collar can be rigid. In at least one embodiment, the collar can be threaded, such as along an outward surface thereof. In at least one embodiment, the collar can be configured to be coupled with the bag. In at least one embodiment, the cap can be rigid. In at least one embodiment, the cap can be threaded, such as along an inwardly facing surface thereof. In at least one embodiment, the cap can be configured to seal the container, such as by being thread ably received on the collar.

In at least one embodiment, the insert can be rigid. In at least one embodiment, the insert can be positioned at least partially within the bag. In at least one embodiment, the insert can be configured to engage the collar outside the bag. In at least one embodiment, the insert can be configured to secure the collar to the bag. In at least one embodiment, the insert can include at least one outwardly extending pin configured to penetrate the bag and engage the collar. In at least one embodiment, the hole in the neck of the bag can receive the pin therethrough. In at least one embodiment, the collar can include at least one inwardly facing slot configured to receive the pin.

In at least one embodiment, the collar can include at least one outwardly extending lever. In at least one embodiment, the insert can include at least one inwardly extending handle. In at least one embodiment, the lever and the handle can facilitate engagement of the insert and the collar, such as by facilitating engagement of the pin and the slot. In at least one embodiment, the lever can also facilitate alignment of the collar with a product dispensing station of a dispensing machine.

In at least one embodiment, container can include an adapter configured to mate the container with a product dispensing station of a dispensing machine. In at least one embodiment, the collar and/or the adapter can include at least one magnet and/or at least one magnet target. In at least one embodiment, the magnet and the magnet target can be positioned to mate the collar to the adapter. In at least one embodiment, both the magnet and the magnet target can be magnetized.

In at least one embodiment, the collar can include at least one identification tag. In at least one embodiment, the adapter can include at least one tag reader that can assist in identification of the container. In at least one embodiment, the collar can include at least one identification tag configured to be accessed by a tag reader of a dispensing machine in order to identify the container.

In at least one embodiment, a product container can include a flexible bag, a rigid insert, a collar, a cap, an adapter, or any combination thereof. In at least one embodiment, the flexible bag can include a resilient neck and/or at least one hole therethrough, such as through the neck. In at least one embodiment, the insert can be positioned at least partially within the bag, such as at least partially within the neck. In at least one embodiment, the insert can include at least one outwardly extending pin. In at least one embodiment, the pin can extend through the hole. In at least one embodiment, the insert can include at least one inwardly extending handle.

In at least one embodiment, the collar can be threaded, such as along an outward surface thereof. In at least one embodiment, the collar can be positioned exterior to the bag. In at least one embodiment, the collar can include at least one inwardly facing slot, such as to receive the pin thereby securing the collar to the bag. In at least one embodiment, the collar can include at least one outwardly extending lever. In at least one embodiment, the lever and/or the handle can facilitate engagement of the pin within the slot and/or otherwise facilitate engagement of the collar and the insert. In at least one embodiment, the lever can facilitate alignment of the collar with a product dispensing station of a dispensing machine. In at least one embodiment, the cap can be threaded, such as along an inwardly facing surface thereof. In at least one embodiment, the cap can be threaded onto the collar, thereby sealing the container.

In at least one embodiment, the container can include an adapter configured to properly position the container with respect to a product dispensing station of a dispensing machine. In at least one embodiment, the collar and/or the adapter can include at least one magnet and/or at least one magnet target. In at least one embodiment, the magnet and the magnet target can be positioned on the collar and/or the adapter, to properly position the collar with respect to the adapter. In at least one embodiment, both the magnet and the magnet target are magnetized.

In at least one embodiment, the collar can include an identification tag or device, such as a radio frequency identification (RFID) tag or chip. In at least one embodiment, the adapter can include a tag reader that can assist in identification of the container. In at least one embodiment, the identification tag can be accessed by a tag reader of a dispensing machine in order to identify the container.

In at least one embodiment, a product container can be assembled by sliding an insert at least partially into a neck of a flexible bag, sliding a collar over the insert and the neck until a pin abuts a longitudinal end of an inwardly facing slot in the collar, rotating the collar about a longitudinal axis of the insert until the pin abuts a terminal point in the slot, or any combination thereof. In at least one embodiment, a product container can be assembled by sliding, longitudinally, an insert at least partially into a resilient neck of a flexible bag, such that at least one pin of the insert protrudes latitudinally outwardly from the neck, sliding, longitudinally, a collar over the insert and the neck until the pin abuts a longitudinal wall of an inwardly facing slot in the collar, rotating the collar about a longitudinal axis of the insert until the pin abuts a terminal point in the slot, or any combination thereof. In at least one embodiment, a method of storing, dispensing, receiving and/or transporting a product can include disposing the product in one or more containers as shown and/or described herein.

Other and further embodiments utilizing one or more aspects of the disclosure can be devised without departing from the spirit of Applicant's disclosure. For example, the devices, systems and methods can be implemented for numerous different types and sizes in numerous different industries. Further, the various methods and embodiments of the devices, systems and methods can be included in combination with each other to produce variations of the disclosed methods and embodiments. Discussion of singular elements can include plural elements and vice versa. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the inventions has been described. Obvious modifications and alterations to the described embodiments are available to those of ordinary skill in the art having the benefits of the present disclosure. The disclosed and undisclosed embodiments are not intended to limit or restrict the scope or applicability of the inventions conceived of by the Applicant, but rather, in conformity with the patent laws, Applicant intends to fully protect all such modifications and improvements that come within the scope or range of equivalents of the following claims.

What is claimed is:

1. A product container comprising:
a flexible bag;
an insert coupled with the bag;
a collar coupled with the bag and the insert; and
a cap removably coupled to the collar for selectively opening and closing the container.

2. The container of claim 1, wherein the insert is disposed at least partially within the bag and is configured to engage the collar outside of the bag for securing the collar to the bag.

3. The container of claim 2, wherein the insert includes at least one outwardly extending pin configured to penetrate the bag and engage the collar.

4. The container of claim 3, wherein the collar includes at least one inwardly facing slot configured to couple with the pin.

5. The container of claim 4, wherein the collar includes at least one outwardly extending lever, wherein the insert includes at least one inwardly extending handle, and wherein the at least one lever and the at least one handle are configured to facilitate engagement of the insert and the collar.

6. The container of claim 5, wherein the at least one lever is further configured to facilitate alignment of the collar with a product dispensing station of a dispensing machine.

7. The container of claim 3, wherein the bag includes a neck configured to receive at least a portion of the insert and at least one hole through the neck configured to receive the at least one pin.

8. The container of claim 1, further comprising an adapter configured to mate the container with a product dispensing station of a dispensing machine.

9. The container of claim 8, wherein one of the collar and the adapter includes at least one magnet and the other of the collar and the adapter includes at least one magnet target, and wherein the magnet and the magnet target are configured to mate the collar to the adapter.

10. The container of claim 8, wherein at least one of the collar and the insert includes an identification tag, and wherein the adapter includes a tag reader configured to support identification of the container.

11. The container of claim 1, wherein at least one of the collar and the insert includes an identification tag configured to communicate with a tag reader of a dispensing machine in order to identify the container.

12. A product container comprising:
a flexible bag including a neck and at least one hole through the neck;
a rigid insert disposed at least partially within the bag;
at least one pin coupled to the insert and disposed in the hole through the neck;
at least one handle coupled to the insert and extending inwardly into an opening of the neck; and
a collar disposed about the opening of the neck;
wherein the collar includes at least one slot configured to couple with the at least one pin for securing the insert and the collar to the bag.

13. The container of claim 12, further comprising a lever coupled to the collar and extending outwardly therefrom, wherein the lever and the handle are configured to facilitate engagement of the insert and the collar.

14. The container of claim 12, further comprising an adapter configured to mate the container with a product dispensing station of a dispensing machine.

15. The container of claim 14, wherein at least one of the collar and the insert includes an identification tag and the adapter includes a tag reader configured to assist in identification of the container.

16. The container of claim 12, wherein at least one of the collar and the insert includes an identification tag configured to be accessed by a tag reader of a dispensing machine in order to identify the container.

17. The container of claim 12, further comprising a cap configured to be selectively coupled to the collar for opening and closing the container.

18. A product container comprising:
a collapsible bag having a closed bottom and a neck with an upwardly facing opening;
a plurality of radially outwardly disposed holes through the neck;
a rigid insert disposed at least partially within the opening;
a plurality of pins coupled to the insert and extending radially outwardly therefrom, wherein each of the plurality of pins is disposed through a corresponding one of the plurality of holes through the neck;
at least one handle coupled to the insert and extending inwardly into the opening of the neck; and
a collar coupled to the neck;
wherein the collar includes a plurality of slots configured to couple with corresponding ones of the plurality of pins; and
wherein the collar and the insert are configured to secure at least a portion of the neck radially between the collar and the insert.

19. The container of claim 18, wherein the collar and the insert are configured to compress at least a portion of the neck radially between the collar and the insert.

20. The container of claim 18, wherein the collar and the insert are removably and rotateably coupled with one another.
